(19) United States
(12) Patent Application Publication
(10) Pub. No.: US 2005/0107526 A1
(43) Pub. Date: May 19, 2005

(54) Polyimide precursor solution, transfer/fixing member and process for producing polyimide seamless belt

(76) Inventors: Hirohisa Katou, Mie (JP); Kazuyoshi Nagata, Mie (JP); Yoshiaki Echigo, Kyoto (JP); Akira Shigeta, Kyoto (JP)

Correspondence Address: Donald S Dowden;Cooper & Dunham, 1185 Avenue of the Americas, New York, NY, 10036, US

(21) Appl. No.: 10/506,694

(22) PCT Filed: Mar. 5, 2003
(86) PCT No.: PCT/JP03/02612

(30) Foreign Application Priority Data
Mar. 5, 2002 (JP) 2002-58692
Oct. 17, 2002 (JP) 2002-303191

(51) Int. Cl. C08K 3/00

(52) U.S. Cl. 524/606

(57) ABSTRACT

The object of the present invention is to provide a polyimide precursor solution having a good coating workability. Another object of the present invention is to provide transfer and fixing parts such as a polyimide seamless belt and the like produced from said polyimide precursor solution. Said polyimide precursor solution is produced by dissolving said polyimide precursor which is a homopolymer or copolymer of a polyamide acid in a solvent mixture of one or more kind(s) of solvent having a lower boiling point under 100° C., and one or more kind(s) of solvent having a higher boiling point of 100° C. or more, wherein said higher boiling point solvent (s) is (are) contained in said solvent mixture in an amount of 5 to 55% by weight.

### FIELD OF THE INVENTION

The present invention relates to a polyimide precursor solution, transfer and fixing parts having a polyimide coating film produced from said polyimide precursor, and a polyimide seamless belt used for said transfer and fixing parts.

### BACKGROUND OF THE INVENTION

Up to now, polyimide precursor has been produced by polymerizing a diamine such as diaminophenyl ether and the like, and a tetracarboxylic acid dianhydride such as pyromellitic acid dianhydride and the like, in a nonprotonical polar solvent such as N-methy-2-pyrrolidone (NMP) and the like. For the solvent used in said polymerization method, generally a monomer is required to be dissolved in a high concentration solvent, containing no water.

It has been known that the solvent used for said polyimide precursor solution need not necessarily to be the solvent in which the monomer is dissolved in a high concentration, and that if the solvent contains water, a solution of the polyimide precursor having a high polymerization degree can be prepared by using a solvent having not so strong solvation (See for instance Patent Literature 1) and it is disclosed in this literature that said solvent is water soluble ether compound such as tetrahydrofuran (THF) and water soluble alcohol compound such as methanol, ethanol, 1-propanol, and 2-propanol. In the case where any of said solvents are used, the solution of the polyimide precursor having a high polymerization degree can be prepared simply and at a low cost and the solvent can be easily removed from said polyimide precursor solution when the molded article is manufactured by said polyimide precursor solution.

Patent Literature 1, U.S. Pat. No. 3,021,979

Tetrahydrofuran (THF), methanol, ethanol, 1-propanol, 2-propanol and the like, each have low boiling points, specifically said solvents' respective boiling point's, at one atmospheric pressure, are all under 100° C., so that a polyimide precursor solution using any of said solvents have a high volatile quality and the solvent can be easily removed from said polyimide precursor solution.

In a case where said polyimide solution is coated on a surface using an applicator such as a dispenser, the viscosity of said polyimide precursor solution may increase as said solvent evaporates during the coating process, and it is feared that said solution, being more viscous is apt to clog the nozzle. Further, one property of said polyimide precursor solution is that it is difficult to maintain a constant viscosity thereof during the coating process, so that when said polyimide precursor solution is used for coating to form coating film, there is the possibility that the thickness of said film may be uneven.

### DISCLOSURE OF THE INVENTION

To solve above described problems, the present invention provide a polyimide precursor solution comprising a polyimide precursor which is either a homopolymer or a copolymer of a polyamide acid made from the reaction between acid component(s) and amine component(s) and having a repetition unit illustrated by the following constitutional formula (1), said polyimide precursor being dissolved in a solvent mixture of one or more kind(s) of solvent having a lower boiling point under 100° C., and one or more kind(s) of solvent having a higher boiling point of 100° C. or more wherein said higher boiling point solvent(s) is (are) included in said solvent mixture in an amount of 5 to 55% by weight. 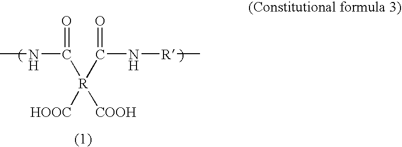
wherein R is a group selected from among the four valence aryl groups illustrated by the following constitutional formulae, and R′ is two valence aryl groups having one to four benzene nuclei,

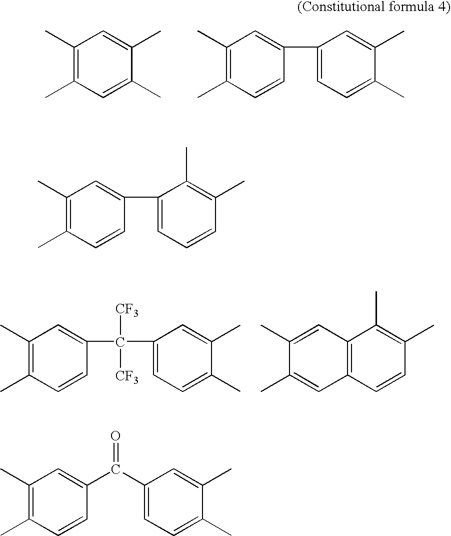

In said polyimide precursor solution, said lower boiling point solvent is the polyimide precursor solution, wherein said lower boiling point solvent(s) is (are) one or more kind(s) of solvent selected from among the group of tetrahydrofuran(THF), methanol, ethanol, 1-propanol, and 2-propanol, and said higher boiling point solvent(s) is (are) or more kinds of solvent selected from among the group of N-methyl-2-pyrrolidone (NMP), N, N-dimethyl formamide (DMF), and N, N-dimethylacetoamide (DMAc).

The desirable acid components are 3,3′,4,4-biphenyl tetracarboxylic acid dianhydride(BPDA), pyromellitic acid dianhydride(PMDA) and 3,3′,4,4′-benzophenone tetracarboxylic acid dianhydride (BTDA), and desirable amine components are 4,4-diphenyl diamino ether (ODA) and p-phenylene diamine (PPD). Further desirable polyimide precursor solutions are a copolymer A of two kinds of acid component, BPDA and PMDA, and two kinds of amine component, ODA and PDA, and a copolymer B of three kinds of acid component, BPDA, PMDA, and BPDA, and two kinds of amine component, ODA and PPD.

In said copolymer A, desirable copolymerization range of the BPDA/PMDA (molar ratio) is 3/7 to 7/3, the ODA/PPD (molar ratio), 3/7 to 7/3, and in said polyimide precursor solution, the desirable weight ratio of said higher boiling point solvent/solid, is 1.5 or less.

Further, in said copolymer B, the desirable copolymerization range of the BPDA/(PMDA+BTDA) (molar ratio) is 1/9 to 9/1, the PMDA/BTDA (molar ratio) being 1/9 to 9/1, the ODA/PPD (molar ratio) being 1/9 to 9/1, and in said polyimide precursor solution, the desirable weight ratio of said higher boiling point solvent/solid is 1.5 or less.

Further, the present invention provides a transfer and fixing parts having a surface on which a polyimide film is formed, said polyimide film being formed by coating said polyimide precursor solution to form a coating film, then heating said coating film at a high temperature to cyclize said polyimide precursor.

Said transfer and fixing parts are such as a middle transfer belt (1), a middle transfer drum (2), a transfer and fixing belt (41), a fixing roller (21) and a fixing belt (31).

Still further, the present invention provides a method for the manufacturing of a polyimide seamless belt comprising the coating of any of said polyimide precursor solution on the surface of a cylindrical core mold to form a coating film, then heating said coating film at a high temperature to cyclize said polyimide precursor and form said polyimide film, then removing said polyimide film from said cylindric core mold.

### BRIEF DESCRIPTION OF DRAWINGS

FIG. 1 is an explanatory perspective view of a transfer system using a middle transfer belt.

FIG. 2 is an explanatory perspective view of a transfer system using a middle transfer drum.

FIG. 3 is an explanatory perspective view of a fixing system using a fixing roller.

FIG. 4 an explanatory perspective view of a fixing system using a fixing belt.

FIG. 5 is an explanatory perspective view of a transfer and fixing system using a transfer and fixing belt.

FIG. 6 is an explanatory perspective view of the results of a dripping test.

### DESCRIPTION OF LETTERINGS

1 a middle transfer belt.
11 a middle transfer drum
21 a fixing roller
31 a fixing belt
41 a transfer and fixing belt

### PREFFERED EMBODIMENT OF THE INVENTION

The present invention is described in details below.

[Polyimide Precursor Solution]

The polyimide precursor solution of the present invention includes a polyimide precursor which is heated or cyclized to form an imidecyclic structure and produce a polyimide precursor which is an organic polymer, and a solvent to dissolve said polyimide precursor.

[Polyimide Precursor]

The polyimide precursor of the present invention is a homopolymer or copolymer of polyamide acid, or a partially imidized homopolymer or copolymer of polyamide acid, having a repetition unit shown by the following constitutional formula (1). 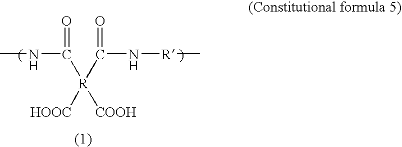
Wherein R is a group selected from among the four valence aryl groups. 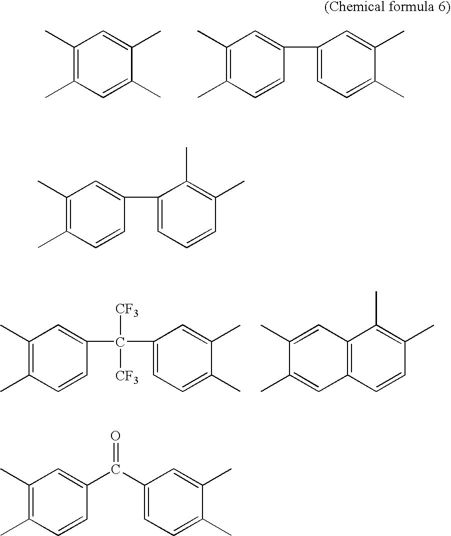
wherein R′ is two valence aryl groups having one to four benzene nuclei. R′ is settled to be such as follows. 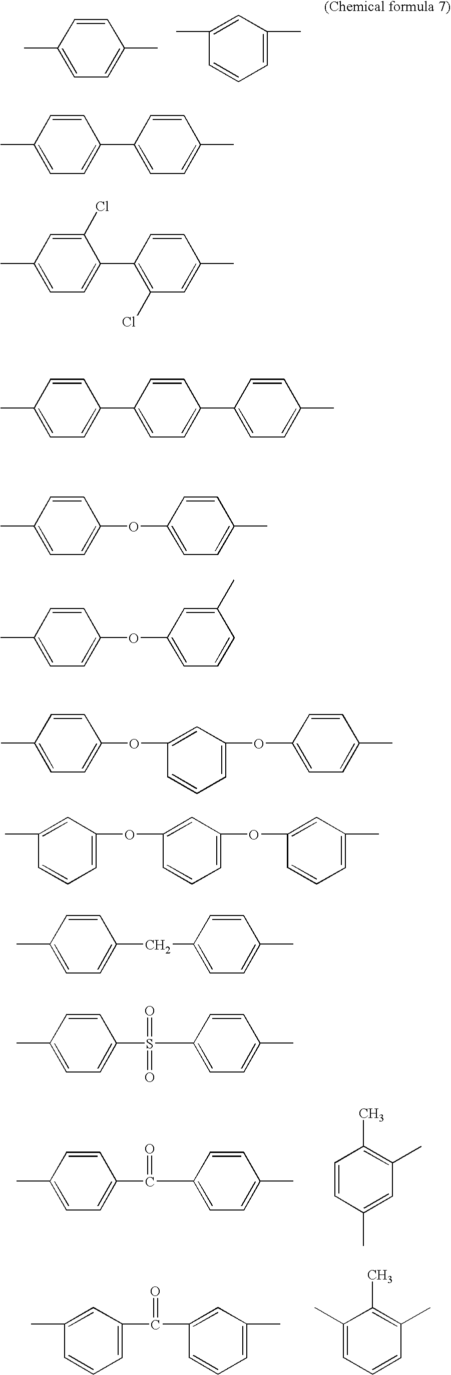 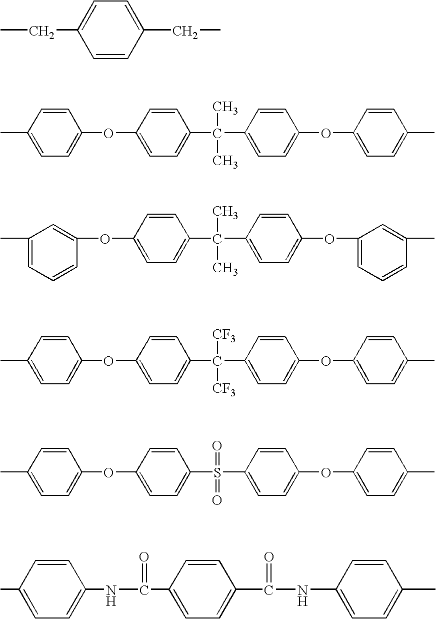
(Solvent Mixture)

The solvent used in said polyimide precursor solution of the present invention is a mixture of one or more kind(s) of solvent having a lower boiling point (said boiling point(s) being at one atmospheric pressure) of under 100° C. and one or more kind(s) of solvent having a higher boiling point of 100° C. or more. Said solvent(s) having the lower boiling point(s) used in the present invention are such as tetrahydrofuran (THF), methanol, ethanol, 1-propanol and the like. Said solvent(s) having the higher boiling point(s) used in the present invention are such as N-methyl-2-pyrrolidone (NMP), N, N′-dimethylformaimide (DMF), N, N-dimethyl aceto amide (DMAc) and the like.

The said solvent(s) used in said polyimide precursor solution of the present invention are a mixture of one or more kind(s) of solvent L having lower boiling point(s), (hereafter L), and one or more kind(s) of solvent H having higher boiling point(s)(hereafter H), and said solvent H is contained in said solvent mixture in the range of between 5 and 55% by weight, more desirably 5 and 40% by weight, and most desirably 10 and 35% by weight.

In a case where said solvent H is contained in said solvent mixture less than 5% by weight, said solvent mixture in said polyimide precursor solution is apt to evaporate, resulting in fears that said coating film will be uneven.

Further, in a case where said solvent H is contained in said solvent mixture more than 40% by weight, said solvent mixture in said polyimide precursor solution evaporates slowly, so that said surface coated solution may droop during the exceedingly slow drying process, resulting in fears that the dried coating film be uneven.

The concentration of said polyimide precursor in said polyimide precursor solution of the present invention may preferably be in the range of between 0.1 and 60% by weight, more preferably between 1 and 25% by weight, and most preferably between 5 and 20% by weight.

Further, in a case where the solvent to solid ratio of H in said polyimide precursor is set to be at a weight ratio of 1.5 or less, drooping of said solution can be effectively prevented during the coating process.

Accordingly, in this case, even ratio of said solvent H is raised to be 55% by weight, the drooping of said solution does not occur.

Still further, in said polyimide precursor solution, the viscosity range to provide for a good coating workability is between 0.2 and 2 Pa·s.

Further, if necessary, fillers such as organic silan, pigment, electroconductive carbon black, metal fine powder, and the like, and other known additives such as grinding powder, dielectrics, lubricants and the like can be added to said polyimide precursor solution in amounts which do not spoil the effect of the present invention.

Said polyimide precursor solution can be prepared by polymerizing one or more kind(s) of tetracarboxylic acid di-anhydride having the following constitutional formula (8), and one or more kinds of diamine having the following constitutional formula (9).

Herein, a method for the preparation of an aromatic polyamide acid solution is illustrated as a preferred embodiment.

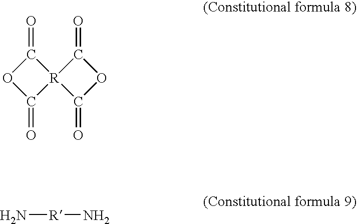

Said aromatic tetracarboxylic acid di-andydride having R as its skeleton, and said aromatic diamine having R′ as its skeleton are polymerized in said solvent mixture. The preferable temperature for said polymerization reaction may be in the range of between −30° C. and 60° C., more preferably between −20° C. and 40° C., the preferable reaction time being in the range of between 1 and 200 minutes, but more preferably between 5 and 100 minutes. The preferable monomer concentration may be in the range of between 0.1 and 30% by weight, but more preferably between 1 and 25% by weight. The ratio of tetracarboxylic acid dianhydride to diamine in said reaction is preferably of 1:1 molar ratio, and, by slightly changing said monomer ratio, slightly, the polymerization degree of said polyamide acid can be adjusted optionally.

Said polyamide acid prepared by said polymerization reaction is such as a polyamide acid copolymer A comprised of BPDA and PMDA as its acid components, with PPD and ODA as its amine components. To balance both the strength and flexibility of a polyimide produced from said copolymer A, the copolymerization range of said copolymer A is preferred to be set at a BPDA/PMDA (molar ratio)=3/7 to 7/3, and a ODA/PPD (molar ratio)=3/7 to 7/3. Another example of a polyamide acid copolymer is, polyamide acid copolymer B, comprised of BPDA, PMDA and BTDA as its acid components, and PPD and ODA as its amine components. The copolymerization range of a polyimide produced from said copolymer B is preferred to be set at a BPDA/PMDA+BTDA (molar ratio)=1/9 to 9/1, with PMDA/BTDA (molar ratio)=1/9 to 911, ODA/PPD (molar ratio)=1/9 to 9/1.

Said polyimide produced from said copolymer B is softer than said polyimide produced from said copolymer A, so that said polyimide produced from said copolymer B can provides transfer and fixing parts having a improved flex fatigue resistance.

Further, said polyamide acid copolymers of the present invention should not be limited to only said copolymers A and B, nor should said polyamide acid copolymers be limited only to random copolymers, but may include block copolymers.

[Polyimide Molded Article]

Polyimide molded article can be manufactured by removing the solvent from said polyimide precursor solution of the present invention, and cyclizing said polyimide precursor by heating.

Said molded articles may be of any kinds of shape, a one dimensional molded article such as a string type molded article, two dimensional molded articles such as film, sheeting, paper like items and the like, and also three dimensional molded articles such as a cylinder, a rectangular parallelepiped, a cubic and any other complicatedly shaped molded article, and the like.

Further, said polyimide molded articles are not limited only to molded items made of strictly polyimide only, but may also be compound in nature, such as a polyimide molded article coated with other known material(s) such as metal, other kinds of synthetic resin or the like.

Said polyimide molded article is described in detail below.

[Transfer and Fixing Parts]

An example of common polyimide molded articles manufactured using said polyimide precursor solution of the present invention, include the transfer and fixing parts typically used in electronic photocopiers, printers, and the like.

Said transfer and fixing parts include the middle transfer belt (1) and middle transfer drum (2) which are used to transfer the toner image formed on the photosensitive body to an image supporter such as paper, and the fixing roller (21) or fixing belt (31) used to fix the toner image transferred to said image supporter, or the transfer and fixing belt (41) used for both transferring and fixing of said image, or the like.

Each transfer and fixing part is described in detail below.

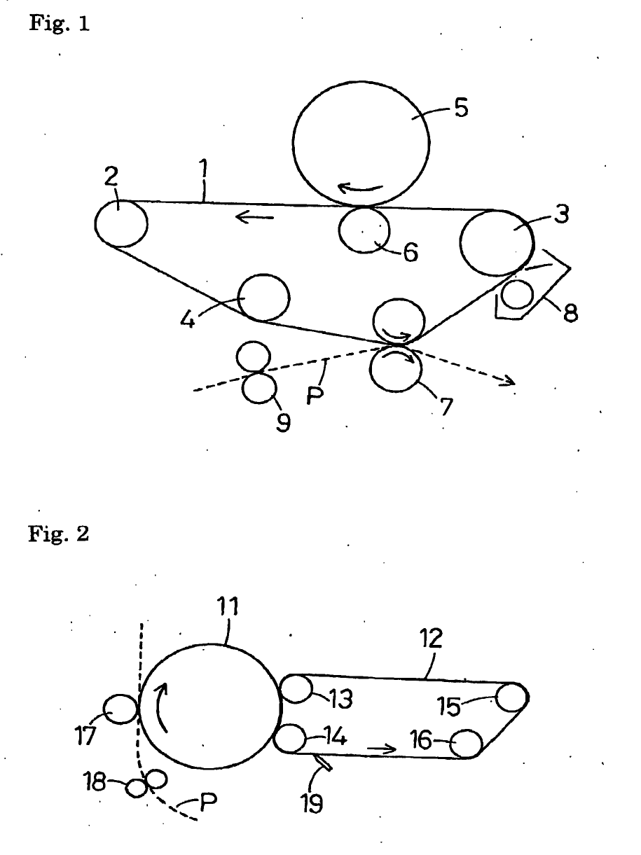

FIG. 1 shows a transfer system using the middle transfer belt (1). Said middle transfer belt (1) is hung on a drive roll (2), a driven roll (3), and a tension roll (4) and comes in contact with a photosensitive drum (5) between said drive roll (2) and said driven roll (3). A primary transfer roll (6) is arranged opposite to said photosensitive drum (5), and a pair of secondary transfer rolls (7, 7) opposite to each other are arranged between said tension roll (4) and said driven roll (3), so that said belt (1) is pinched between said pair of secondary transfer rolls (7, 7), and further, a bolt cleaner (8) for said belt (1) is arranged opposite to said driven roll (3).

In said transfer system, the toner image formed on said photosensitive drum (5) is primarily transferred to said middle transfer belt (1) being driven at an equal speed to said photosensitive drum (5), and said toner image transferred to said belt (1) is further secondarily transferred to the image supporter such as paper (P), which is introduced between said pair of secondary transfer rolls (7, 7) with an introducing roll (9), and then the toner remaining on said belt (1) after said secondary transfer is removed by said belt cleaner (8).

FIG. 2 shows a transfer system using a middle transfer drum (11). Said middle transfer drum (11) comes into contact with a photosensitive belt (12) hung on rolls (13, 14, 15, 16) and a transfer roll (17).

In said transfer system, the toner image on said photosensitive belt (12) is primarily transferred to said middle transfer drum (11), being driven at an equal speed to said photosensitive belt (12), and then said toner image transferred on said drum (11) is secondarily transferred to a image supporter such as paper (P) being introduced between said drum (11) and said transfer roll (17) with an introducing roll (18). The toner remaining on said belt (12) after said primary transfer is removed by a belt cleaner (19).

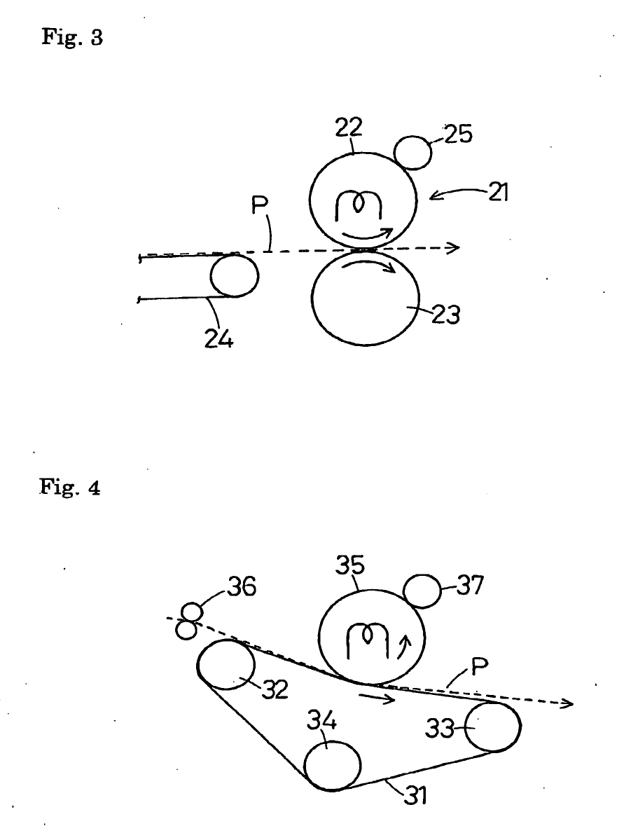

FIG. 3 shows a fixing system using a fixing roller (21). Said fixing roller (21) consists of a heating roller (22) and a press roller (23) set onto said heating roller (22). Said image supporter such as the paper (P) is introduced between said rollers (22, 23), each rotating at an equal speed, and toner of said toner image transferred on said paper (P), is melted by coming into contact with said heating roller (22), fixing said toner image to said paper (P). The toner remaining on said heating roller (22), after fixing, is then removed by a cleaning roll (25).

FIG. 4 shows a fixing system using a fixing belt (31). Said belt (31) is hung on a drive roll (32), a driven roll (33) and a tension roll (34), and a heating roller (35) is set onto said belt (31). Said belt (31) and said roller (35), each rotating at an equal speed, and said image supporter, such as paper (P), on which the toner image is to be transferred is then introduced between said belt (31) and said roller (35), by an introducing roll (36), after which said toner image is fixed to said paper (P).

The toner remaining on said heating roller (35) is then removed by a cleaning roll (37).

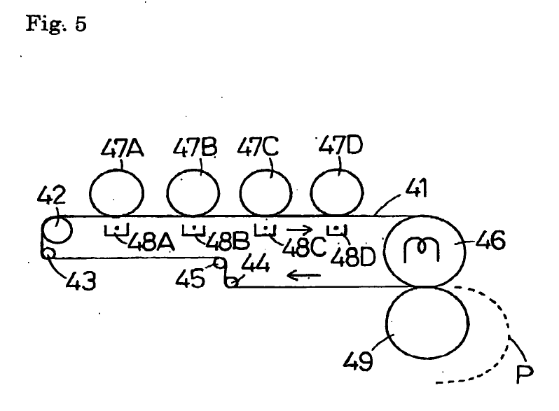

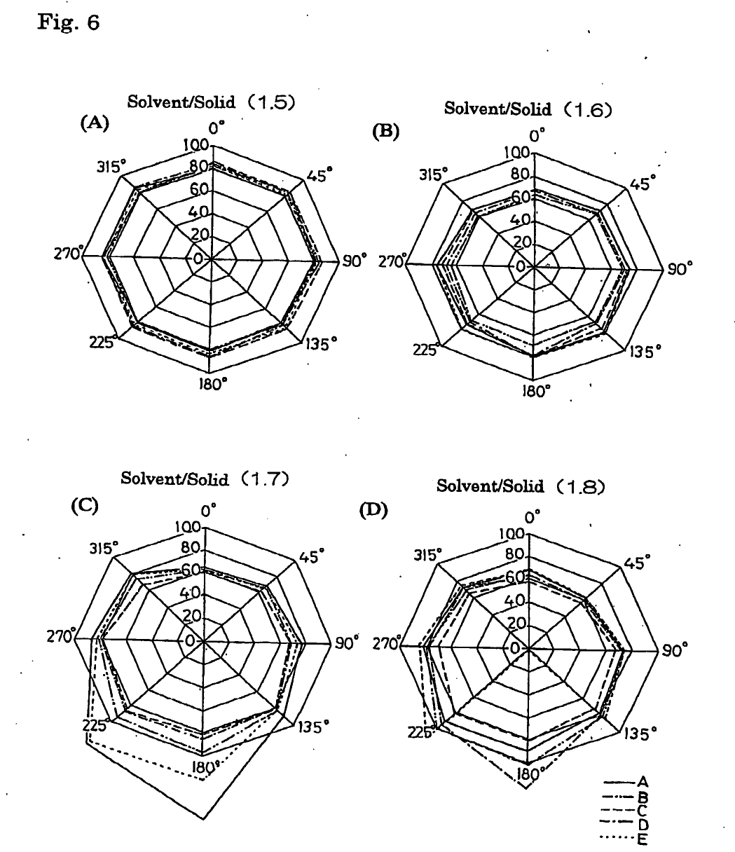

FIG. 5 shows a transfer fixing system using a transfer fixing belt (41). Said transfer and fixing belt (41) is hung on a drive roll (42), a pair of guide rolls (43, 44), a tension roll (45) and a heating roller (46), and four photosensitive drums (47A, 47B, 47C, 47D) respectively come in contact with said belt (41) between said drive roll (42) and said heating roller (46), said drums (47A, 47B, 47C, 47D) each carrying different colored toner images, and four transfer apparatus (48A, 48B, 48C, 48D) are arranged opposite to said drums (47A, 47B, 47C, 47D), and a press roller (49) is set onto said heating roller (46).

In said system, the multicolored toner image is primarily transferred to said belt (41) from said four photosensitive drums (47A, 47B, 47C, 47D), after which the image supporter such as paper (P) is introduced between said heating roller (46) and said press roller (49), and said multicolored toner image on said belt (41) is secondarily transferred to said paper (P), and heated to fix.

In said transfer and fixing parts, said middle transfer drum (11) and said fixing roller (21) essentially consist of a base such as cylindrical core parts, and a polyimide coating film being formed on the surface of said base. Said polyimide film is formed by coating said polyimide precursor solution on the surface of said base to form the coating film of said polyimide precursor solution, and heating said coating film, at a high temperature, to cyclize said polyimide precursor.

Further, in said middle transfer belt (1) said fixing belt (31), and said transfer and fixing belt (41), commonly said middle transfer belt (1) and said transfer and fixing belt (41) contain electroconductive materials such as carbon black, electroconductive metaloxide, and the like, however these belts essentially consist of only polyimide film.

Said polyimide film is manufactured by coating said polyimide precursor solution on the surface of said cylindrical core mold to form a coating film of said polyimide precursor solution, then heating said coating film at a high temperature to cyclize said polyimide precursor and form a polyimide film on said cylindrical core mold, then removing Raid polyimide film from said core mold. The resulting belt, made of said polyimide film, is seamless, hence said belt is called a polyimide seamless belt.

The method for manufacturing said polyimide seamless belt is described below precisely.

[A Method for Manufacturing the Polyimide Seamless Belt]

A method for manufacturing a polyimide seamless belt comprises the coating of said polyimide precursor solution on the surface of the cylindrical core mold to form a coating film of said polyimide precursor solution (Process 1), then heating said coating film, to cyclize said polyimide precursor, and form a polyimide film on said cylindrical core mold (Process 2), then removing said polyimide film from said core mold (Process 3).

(Process 1)

Said cylindrical core mold on which said polyimide film is formed, includes a core mold made from aluminum, copper, stainless steel, and the like, a core mold whose surface is treated with a release agent such as a silicone release agent, or a fluoride release agent and the like, a core mold on whose surface fluorocarbon resin coating film is formed, or a core mold wherein a core body is inserted into a fluorocarbon resin tube, said core body being removable. Said coating film of said polyimide precursor solution formed on the surface of said cylindrical core mold may be formed on either the inside or outside of said cylindrical core mold.

As methods for applying said polyimide precursor solution on said cylindrical core mold, any of known coating method such as flow coating, dip coating, knife coating and the like can be applied.

Said polyimide precursor solution of the present invention has a good coating workability, so that said polyimide precursor solution can be coated on said cylindrical core mold using many kinds of the coating method to form a coating film of said polyimide precursor solution.

(Process 2)

Said coating film formed on the surface of said cylindrical core mold is then heated to cyclize said polyimide precursor, and form a polyimide film. The heating temperature may be in the general range of between 100° C. and 400° C.

Said heating process which concludes the cyclizing of said polyimide precursor may be performed in one step or multi-steps, or said polyimide precursor may be partially cyclized by heating, and then removed once from said cylindrical core mold, and another cylindrical core mold is inserted into said partially cyclized polyimide precursor film, and said partially cyclized polyimide film is further heated to complete the polyimide precursor's cyclizing process. In this case, a plural number of cylindrical core molds are prepared and may be inserted into said partially cyclized polyimide film to extend said film from the inside of said film, and said extended partially cyclized polyimide film may be heated to complete cyclizing process.

(Process 3)

By the removing of the resulting polyimide film from said cylindrical core mold, a polyimide seamless belt is manufactured.

The present invention is more concretely described by the preferred embodiments below, however these embodiments do not limit the scope of the invention.

EXAMPLES 1 to 4 relate to said polyimide precursor solution.

### EXAMPLE 1

A 6.80 g portion of 4.4′-diphenyldiaminoether (ODA) was dissolved in a solvent mixture containing 56 g of THF, 14 g of methanol, and 30 g of NMP, under the dry air atmosphere, after which the resulting solution was kept at 10° C. A 7.48 g portion of pyromellitic acid dianhydride (PMDA) was slowly added to said solution, after which the resulting solution was stirred at 10° C. for 1 hour to produce a uniform yellow solution. Said resultant solution was then further stirred at 25° C. for 48 hours to prepare a polyimide precursor solution. The viscosity of said polyimide precursor solution was 1.5 Pa·s.

### EXAMPLE 2

A uniform polyimide precursor solution was prepared using the same process as described in EXAMPLE 1, with the exception that a solvent mixture containing 76 g of NMF, 19 g of methanol and 5 g of NMP was used. The viscosity of said polyimide precursor solution was 0.8 Pa·s.

### EXAMPLE 3

A uniform polyimide precursor solution was prepared using the same process as described in EXAMPLE 1 with the exception that a solvent mixture containing 64 g of THF, 16 g of methanol, and 20 g of NMP was used. The viscosity of said polyimide precursor solution was 1.3 Pa·s.

### EXAMPLE 4]

A uniform polyimide precursor solution was prepared using the same process as described in EXAMPLE 1 with the exception that a solvent mixture containing 48 g of THF, 12 g of methanol, and 20 g of NMP was used. The viscosity of said polyimide precursor solution was 1.8 Pa·s.

[Comparison 1]

A uniform polyimide precursor solution was prepared using the same process as described in EXAMPLE 1 with the exception that a solvent mixture containing 80 g of THF and 20 g of methanol was used. The viscosity of said polyimide precursor solution was 0.6 Pa·s.

[Comparison 2]

A uniform polyimide precursor solution was prepared using the same process as described in EXAMPLE 1, with the exception that a solvent mixture containing 79 g of THF, 20 g of methanol and 1 g of NMP was used. The viscosity of said polyimide precursor solution is 0.6 Pa·s.

[Comparison 3]

A uniform polyimide precursor solution was prepared using the same process as described in EXSMPLE 1 with the exception that a solvent mixture containing 32 g of THF, 8 g of methanol and 60 g of NMP was used. The viscosity of said polyimide precursor solution was 3, 3 Pa·s.

[Comparison 4]

A uniform polyimide precursor solution was prepared using the same process as described in EXAMPLE 1 with the exception that only 100 g of NMP was used as solvent. The viscosity of said polyimide precursor solution was 9.8 Pa·s.

Each polyimide precursor solution sample prepared in EXAMPLES 1 to 4 and COMPARISONS 1 to 4 was coated on a glass plate at a thickness of about 700 μm using a film applicator for a coating film, and each coating film was dried at 40° C. for 30 minutes, and then again at 60° C. for 3 hours.

Each dried coating film was then dissolved in DMSO-d6, the remaining quantity of solvent then being determined by NMR analysis, with the remaining solvent ratio being calculated from the quantity of solvent remaining.

Further, the tackiness of each coating film after drying was determined by pushing one's finger onto said coating film surface. The results are shown in Table 1. Symbols representing the tackiness of said coating film in Table 1, are as follows.

TABLE 1

| | Comparison 1 | Comparison 2 | Example 2 | Example 3 | Example 1 | Example 4 | Comparison 3 | Comparison 4 |
|---|---|---|---|---|---|---|---|---|
| NMP fraction | 0 | 1 | 5 | 20 | 30 | 40 | 60 | 100 |
| in the solvent | | | | | | | | |
| (wt %) | | | | | | | | |
| Remaining | 12 | 13 | 17 | 31 | 40 | 49 | 76 | 105 |
| solvent ratio | | | | | | | | |
| (wt %) | | | | | | | | |
| Tackiness | ◯ | ◯ | ◯ | ◯ | ◯ | Δ | X | X |

◯ No change in the coating film
Δ Slight tackiness on the coating film
X The coating film sticks to one's fingers

Referring to Table 1, it is understood that the drying speed can be controlled by adjusting the fractional amount of NMP in the solvent. Further, all of the polyimide precursor solutions of EXAMPLES 1 to 4 have moderate drying speeds, so that easily recognizable imperfections, such as uneven thickness of coverage, are rarely produced.

EXAMPLES 5 to 8 relate to the methods for manufacturing the seamless belt.

### EXAMPLE 5

(Flow Coating)

The surface of an aluminum cylindrical core mold, was treated with a silicon release agent, while on the inside of said metal core mold, a duct for cooling water as a means for the lowering the temperature was formed, and there a polyimide precursor solution was coated on the surface of said metal core mold by a flow coater to form a coating film. During coating process, said metal core mold was rotated and moved vertically along the axis of said core mold and said polyimide precursor solution was flowed down on the surface of said a cylindrical metal core mold from the flow coater to form said coating film.

Said coating film of said polyimide precursor solution coated uniformly and formed on the surface of said metal core mold, was heated at a high temperature to cyclize said polyimide precursor and form a polyimide film.

The temperature of said healing process was in the range of between about 150 and, 400° C. for about 0.5 to 5 hours.

The resulting polyimide film formed on the surface of said metal core mold was then removed from said metal core mold to obtain a polyimide seamless belt (inner diameter: 30 mm, width: 300 mm, thickness: 701 μM).

When said polyimide film was removed from said core mold, the cooling water was introduced into said cooling water duct to cool said core mold, while, at the same time, said polyimide film on the surface of said core mold, being heated from the outside by such as a far-infrared ray heater or the like.

### [EXANPLE 6

(Rotational Molding)

A polyimide precursor solution was injected into a metal cylindrical core mold having a diameter of 30 mm, and a uniform coating film of said polyimide precursor solution was formed by rotating said cylindrical core mold, and then said coating film was heated by gradually raising the temperature to 50° C. After the heating and rotating of said core mold was stopped, the resulting coating film was removed from the inside of said cylindrical core mold, and a cylindrical fluorocarbon resin tube with a diameter of 29.5 mm was inserted into said coating film, after which it was heated at 315° C. for 15 minutes to cyclize said polyimide precursor of said coating film and produce a polyimide film. After heating, the resulting polyimide film was cooled to room temperature, and then removed from said fluorocarbon resin tube, obtaining a polyimide seamless belt, having a uniform thickness, an inner diameter of 30 mm, width of 300 mm, and film thickness of 70 μm.

### EXAMPLE 7

(Dip Coating)

A polyimide precursor solution was coated, by dip coating (pulling up rate: 16 cm/min), on a surface of fluorocarbon resin tube, forming a coating film, said tube having a diameter of 29.5 mm, in which a removable metal core was inserted. Said coating film was heated by gradually raising the temperature to 200° C., and after heating, said metal core was removed from said fluorocarbon resin tube and then the resulting coating film was removed from said fluorocarbon resin tube. Said removed coating film was then fitted to another metal core mold, heated at 350° C., to cyclize the polyimide precursor and thus produce a polyimide film, after which said polyimide film was removed from said metal core mold, obtaining a polyimide seamless belt, having a uniform thickness, an inner diameter of 30 mm, width of 200 mm, and thickness of 70 μm.

### EXAMPLE 8

(Knife Coating)

A polyimide precursor solution was coated, with a knife edge, on a surface of fluorocarbon resin tube, forming a coating film, said tube having a diameter of 29.5 mm, in which a removable metal core was inserted. Said coating film was gradually heated by raising the temperature to 200° C., after which said metal core was removed from said fluorocarbon resin tube, and the resulting coating film was removed from said fluorocarbon tube.

Said coating film, once removed, was then fitted to two other metal core molds. Said coating film was then extended by two metal cores from the inside of said coating film, and said coating film was heated at 350° C. to cyclize polyimide precursor and produce a polyimide film.

The resulting polyimide film was further removed from said metal core molds to obtain a polyimide seamless belt, having a uniform thickness. The inner diameter of said polyimide seamless belt being 30 mm, width 200 mm, with a film thickness of 70 μm.

### EXAMPLES 9 to 19

Using the acid dianhydrides and diamines shown in Table 2, polyimide precursors were prepared by the same method as in EXAMPLE 1. The numbers relating to acid dianhydrides and diamines, in Table 2, show molar ratio, numbers relating to solvents, NMP, DMAc, and THF show weight ratio and numbers relating to solid content show % by weight.

TABLE 2

| | | | | | | | | | | Solvent | |
|---|---|---|---|---|---|---|---|---|---|---|---|
| | Acid dianhydride | | | Diamine | | Solid | | | | to solid | Viscosity |
| Examples | PMDA | BPDA | BTDA | PPD | ODA | (%) | NMP | DMAc | THF | ratio of H | Pa · s |
| 9 | 40 | 60 | 0 | 40 | 60 | 25 | 0 | 37.5 | 37.5 | 1.5 | 0.94 |
| 10 | 40 | 60 | 0 | 40 | 60 | 25 | 18.75 | 18.75 | 37.5 | 1.5 | 0.51 |
| 11 | 30 | 70 | 0 | 50 | 50 | 25 | 0 | 37.5 | 37.5 | 1.5 | 0.97 |
| 12 | 100 | 0 | 0 | 0 | 100 | 10 | 15 | 0 | 75 | 1.5 | 0.45 |
| 13 | 100 | 0 | 0 | 20 | 80 | 10 | 15 | 0 | 75 | 1.5 | 0.50 |
| 14 | 80 | 20 | 0 | 20 | 80 | 10 | 15 | 0 | 75 | 1.5 | 0.79 |
| 15 | 80 | 20 | 0 | 40 | 60 | 10 | 15 | 0 | 75 | 1.5 | 0.68 |
| 16 | 70 | 30 | 0 | 30 | 70 | 10 | 15 | 0 | 75 | 1.5 | 0.45 |
| 17 | 60 | 40 | 0 | 40 | 60 | 25 | 0 | 51 | 24 | 2.0 | 0.74 |
| 18 | 10 | 70 | 20 | 50 | 50 | 25 | 0 | 37.5 | 37.5 | 1.5 | 1.24 |
| 19 | 10 | 60 | 30 | 40 | 60 | 25 | 0 | 37.5 | 37.5 | 1.5 | 1.20 |

Each polyimide precursor solution was coated on the surface of a cylinderical bar of polytetrafluoro ethylene (PTFE) resin by a flow coater and after coating said cylindrical bar was dried and heated at 310° C.

After drying and heating respectiely, the resulting coating film was then removed from said cylindrical bar, obtaining a seamless belt sample.

The results of determinations of the mechanical properties of these samples are shown in Table 3.

TABLE 3

| | | | | | | Flex fatigue |
|---|---|---|---|---|---|---|
| | Thickness | Tensile | Tensile | Extension | Buckling | The number of |
| | of film | elasticity | strength | ratio | load | times |
| Examples | (μm) | (N/mm²) | (N/mm²) | (%) | (N) | (K times) |
| 9 | 80.0 | 3845 | 204 | 62.5 | 67.0 | 1807 |
| 10 | 83.0 | 3943 | 177 | 45.9 | 54.8 | |
| 11 | 85.0 | 4219 | 218 | 69.5 | 77.5 | ≧1500 |
| 12 | 71.3 | 3182 | 133 | 48.2 | 38.4 | ≧1200 |
| 13 | 73.0 | 2693 | 102 | 50.0 | | |
| 14 | 60.0 | 3108 | 112 | 19.8 | | |
| 15 | 70.0 | 3778 | 136 | 18.0 | | 480 |
| 16 | 87.2 | | 108 | 8.6 | | 120 |
| 17 | 79.0 | 4204 | 167 | 35.1 | 49.4 | 1430 |
| 18 | 89.7 | 4224 | 230 | 50.0 | | ≧2000 |
| 19 | 86.7 | 4488 | 210 | 50.0 | | ≧2000 |

Referring to Table 3, it is recognized that samples of EXAMPLES 9 to 11 which are polyamide copolymers using PMDA and BPDA as acid dihydrides, with PPD and ODA as diamines, each have superior mechanical properties to the sample in EXAMPLE 12 which, is a polyamide copolymer using PMDA only as an acid dianhydride with ODA only as diamine, and the sample from EXAMPLE 13 using only PMDA as acid dianhydride and both PPD and ODA as diamine.

Further, it is recognized that the samples from EXAMPLES 18 and 19 which are polyimide copolymer using PMDA, BPDA, and BTDA as acid dianhydrides, with PPD and ODA as diamines, each have superior flex fatigue times than those of other EXAMPLES.

Further, the sample from EXAMPLE 17 having a solvent to solid ratio of H greater than 1.5 weight ratio (the weight ratio being 2.0), shows the solution's drooping phenomenon when said coating film is formed, and the sample becomes uneven.

As a result, the sample from EXAMPLE 17 has degraded mechanical properties as compared with samples from EXAMPLES 9 to 11.

(Solution Drooping Test)

Four kinds of the samples using said polyamide acid from EXAMPLE 9 wherein the solvent to solid weight ratios of H of 1.5, 1.6, 1.7, and 1.8 were respectively coated by flow coating on the surfaces of the cylindrical bars of PTFE resin having a diameter of 30 mm, after which the resulting coating films were dried and heated respectively at 310° C. The thickness of the resulting films were respectively measured at positions of 0°, 45°, 90′, 135°, 180°, 225°, 270°, 315° around said cylindrical bars. These measurements were carried out from 5 positions (A, B, C, D and E) being divided into 5 equal lengths along each cylindrical bar. A and E being located at either end of each cylindrical bar, C being located at the center of said cylindrical bar, B being located in the middle position between one end A and the center C, and D being located in the middle position between the opposite end E and the center C. The results are shown in FIG. 6, a, b, c, and d.

As shown in FIG. 6, the sample having a solvent to solid weight ratio of H of 1.5 forms the coating film whose thickness is substantially uniform at any angle position, while the sample having a solvent to solid weight ratio of H of 1.6 forms the coating film whose thickness is partially uneven in the range of between 90° C. and 315° C., and the samples having solvent to solid weight ratio of H of 1.7 and 1.8 form the coating films whose thicknesses are partially uneven in the range of between 135° C. and 270° C., making these samples remarkably susceptible to solution drooping phenomenon.

### POSSIBILITY OF INDUSTRIAL USE

Said polyimide precursor solution of the present invention has an excellent coating workability, so that many kinds of molded polyimide articles can be easily manufactured using said polyimide precursor solution.

1: A polyimide precursor solution for coating comprising a polyimide precursor which is either a homopolymer or a copolymer of a polyamide acid made from the reaction between acid component(s) and amine component(s) and having a repetition unit illustrated by the following a constitutional formula, said polyimide precursor being dissolved in a solvent mixture of one or more kind(s) of solvent having a lower boiling point under 100° C., and one or more kind(s) of solvent(s) having a high boiling point selected from among the group of N methyl-2-pyrrolidone (NMP), N,N-dimethyl formanide (DMF), and N,N-dimethylacetoamide (DMAc), wherein said higher boiling point solvent(s) is included in said solvent mixture in an amount of 5 to 55% by weight. 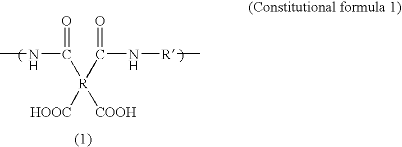
wherein R is a group selected from among the four valence aryl groups illustrated by the following constitutional formulae, and R′ is two valence aryl groups having one to four benzene nuclei,

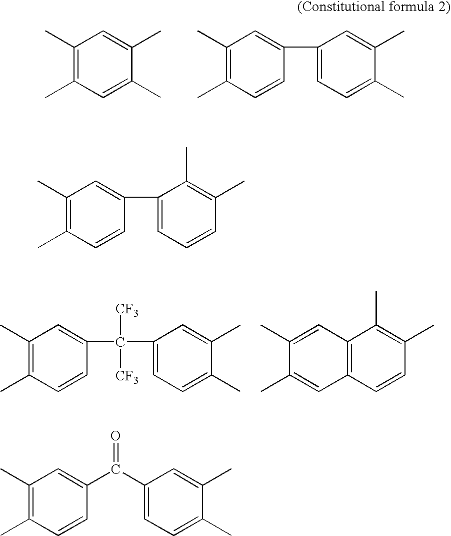

2: A polyimide precursor solution for coating of claim 1, wherein said lower boiling point solvents(s) is (are) one or more kind(s) of solvent selected from among the group of tetrahydrofuran (THF), methanol, ethanol, 1-propanol, and 2-propanol, and said higher boiling point solvent(s) is (are) one or more kind(s) of solvent selected from among the group of N-methyl-2-pyrrolidone (NMP), N,N-dimethyl formamide (DMF), and N,N-dimethylacetoamide (DMAc).

3: A polyimide precursor solution for coating of claim 1, wherein said acid component(s) is (are) one or more kind(s) of acid component selected from among the group of 3,3′,4,4′-biphenyl tetracarboxylic acid dianhydride, pyromellitic acid dianhydride, and 3,3′,4,4′-benzophenone tetracarboxylic acid dianhydride.

4: A polyimide precursor solution for coating of claim 1, wherein said amine component(s) is (are) one or more kind(s) of amine component selected from among the group of 4,4-diphenyl diamino ether and p-phenylene diamine.

5: A polyimide precursor solution for coating of claim 1, wherein said acid component(s) is (are) one or more kind(s) of acid component selected from among the group of 3,3,4,4′-biphenyl tetracarboxylic acid dianhydride, pyromellitic acid, dyanhydride and 3,3,4,4′-benzophenone tetracarboxylic acid dianhydride, and said amine component(s) is (are) one or more kind(s) of amine component selected from among 4,4-diphenyl diamino ether and p-phenylenediamine.

6: A polyimide precursor solution for coating of claim 1, wherein the weight ratio of the higher boiling point solvent/solid component is of 1.5 or less weight ratio.

7: Transfer and fixing parts having a surface on which a polyimide film is formed, said polyimide film being formed by coating any of said polyimide precursor solution(s) for coating of claim 1 to form a coating film, and heating said coating film at a high temperature to cyclize said polyimide precursor.

8: A polyimide precursor solution of claim 7, wherein said transfer and fixing parts are a middle transfer belt, a middle transfer drum, a transfer and fixing belt, a fixing roller, and a fixing belt.

9: A method for manufacturing a polyimide seamless belt comprising the coating of any of said polyimide precursor solution(s) of claim 1 on the surface of a cylindrical core mold to form a coating film, then heating said coating film at a high temperature to cyclize said polyimide precursor and form a polyimide film, then removing said polyimide film from said cylindrical core mold.
